(19) United States
(12) Patent Application Publication
(10) Pub. No.: US 2014/0030395 A1
(43) Pub. Date: Jan. 30, 2014

(54) PRODUCT-SEGREGATING CONTAINER AND METHOD FOR TESTING PRODUCTS PROCESSED IN A PRODUCT TUMBLING APPARATUS

(71) Applicant: Laitram, L.L.C., Harahan, LA (US)

(72) Inventors: Joseph F. Kovacs, New Orleans, LA (US); Brent A. Ledet, River Ridge, LA (US); Christopher G. Greve, Covington, LA (US)

(21) Appl. No.: 13/943,471

(22) Filed: Jul. 16, 2013

Related U.S. Application Data
(60) Provisional application No. 61/674,890, filed on Jul. 24, 2012.

(51) Int. Cl. A47J 27/04

(52) U.S. Cl. CPC A47J 27/04
USPC 426/233; 99/409

(57) ABSTRACT

A rigid, foraminous, ball-shaped container for housing products treated in a product-tumbling apparatus. The container allows selected products to be segregated from a mass flow of products and can protect a sensor mounted in the container from damage that can be caused by the tumbling action.

### BACKGROUND

The invention relates generally to food cookers and more particularly to containers housing food products being processed in a rotary blancher or other product-tumbling apparatus.

Rotary blanchers are tanks filled with a cooking fluid, such as heated water, housing a perforate cylindrical drum through which flights of a rotating helical screw convey food products in a continuous product-tumbling cooking process. Rotary blanchers are often used to blanch vegetables. Sometimes it is helpful to know certain conditions, e.g., the core temperatures, of vegetables as they are being conveyed through the blancher or to isolate a sample of the vegetables from the mass flow of vegetables to check the quality of the blanching process. Many sensors are delicate and not always adaptable to being tumbled through a rotary blancher or other product-tumbling apparatus.

### SUMMARY

Features of the invention are embodied in a container for housing products undergoing processing in a product-tumbling apparatus, such as vegetables being blanched in a rotary blancher. The container comprises a foraminous, ball-shaped shell surrounding an interior chamber. The shell has an outer surface with a multiplicity of small openings that extend through the outer surface to the interior chamber and a larger opening that extends through the outer surface to the interior chamber. A removable lid, which is receivable in the larger opening, has an outer surface that is continuous with the outer surface of the shell when the lid is received in the larger opening. The small openings are small enough to prevent products from escaping the interior chamber. The larger opening is large enough to allow products to be inserted into and removed from the interior chamber.

In another aspect of the invention, a method for testing a product sample processed in a product-tumbling apparatus comprises: (a) inserting a product sample into a foraminous, ball-shaped container having a sensor with a probe penetrating the product sample to make sensor measurements of a condition of the product sample; (b) admitting the container into a product-tumbling apparatus; (c) subjecting the product sample in the product-tumbling apparatus to a treatment that affects the condition of the product sample; and (d) downloading the sensor measurements.

### BRIEF DESCRIPTION OF THE DRAWINGS

These aspects and features of the invention, as well as its advantages, are described in more detail in the following description, appended claims, and accompanying drawings, in which:

FIGS. 1A-1C are exploded, side, and cross-sectional views of a ball-shaped container embodying features of the invention;

FIGS. 2A-2C are exploded, side, and cross-sectional views of another version of the container as in FIG. 1, including a sensor;

FIGS. 3A and 3B are end and cross-sectional views of a rotary blancher in which a container as in FIG. 1B or FIG. 2B may be used;

FIG. 4 is a schematic block diagram of circuitry that includes the sensor of FIG. 2; and

FIGS. 5A-5C are exploded, side, and cross-sectional views of another version of the container as in FIG. 1 without a lid.

### DETAILED DESCRIPTION

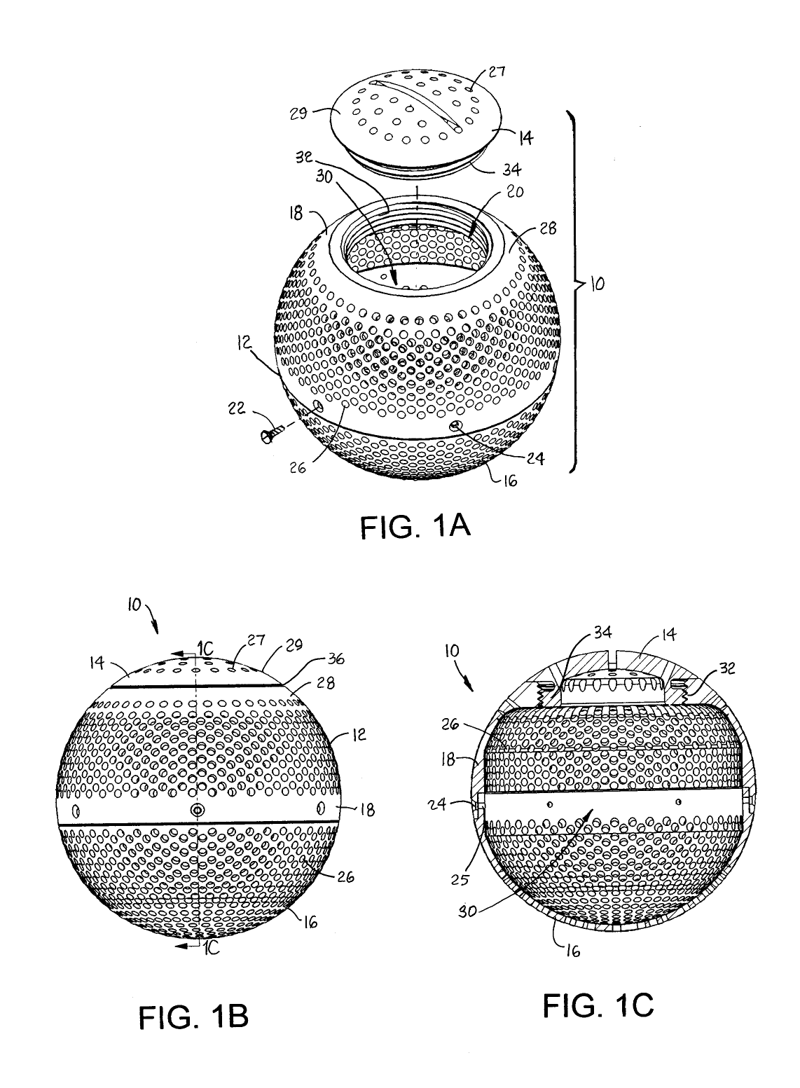

One version of a container embodying features of the invention for isolating one or more product samples from a mass of products subjected to tumbling is shown in FIGS. 1A-1C. The container 10 includes a foraminous, ball-shaped shell 12 and a lid 14. The shell shown is made of two shell portions—a first hemispherical portion 16 and a second portion 18 also hemispherical but with a large circular opening 20 in a polar region of the hemisphere. The two portions 16, 18 are fastened together along an overlapping equatorial region by flat-head screws 22, for example, through countersunk holes 24 in the second side shell portion 18 and into aligned threaded holes 25 in the first shell portion 16.

The foraminous shell 12 is characterized by a multiplicity of small openings 26 that open onto an outer surface of the shell and extend through the shell to an interior cavity 30 in which products may be received. The lid 14 also includes small openings 27 in its outer surface 29 that extend to the interior cavity 30 when the lid is received in the larger opening 20 in the shell 12. The larger opening is rimmed by a threaded throat region 32. The lid 14 includes a threaded region 34 that screws into the threaded larger hole 20. When the lid is fully seated to close off the interior chamber, the lid's outer surface 29 is continuous, except for a circular seam 36, with the outer surface 28 of the shell 12. The multiplicity of small openings 26, 27 leading into the interior cavity 30 provide an open area of at least 30% of the total outer surface area of the container 10. The larger opening 20 is large enough to admit products into the interior cavity 30. The small openings 26, 27 are small enough to prevent products from escaping the interior cavity. And the open area provided by the multiplicity of small holes provides sufficient access to the product by heating fluids, for example, to carry out the process with minimal disturbance.

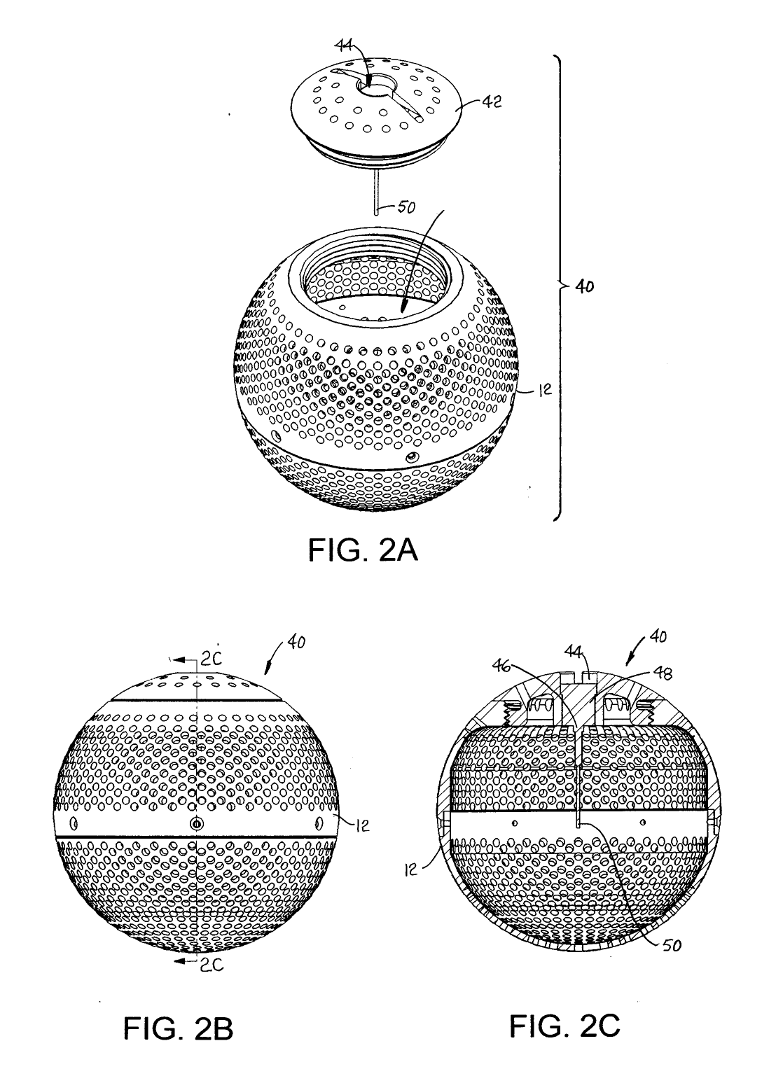

Another version of a container embodying features of the invention is shown in FIGS. 2A-2C. In this version, the shell 12 of the container 40 is the same as in FIGS. 1A-1C. But this container 40 has a lid 42 with a cavity 44 for a sensor 46 and its associated electronic circuitry 48. The sensor, which may be a temperature sensor, detects a condition, e.g., the core temperature, of an individual product, a mass of products, or an ambient condition in the vicinity of a product housed in the interior chamber 30. The sensor 46 may include a probe 50 that extends into a more central region of the interior chamber or that can be inserted into the interior of an individual product, for example, to measure its core temperature. In this way, the product and the sensor are protected from collisions with products outside the container 40 or other structures against which the container bumps.

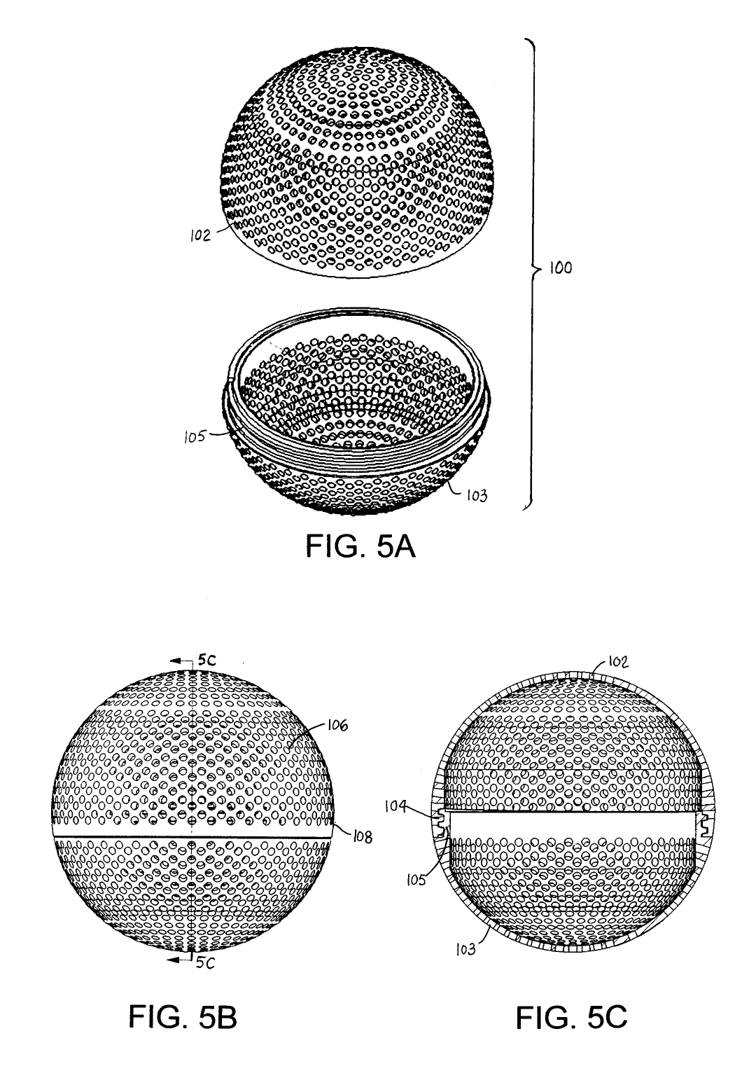

Yet another version of a container embodying features of the invention is shown in FIGS. 5A-5C. In this version, the container 100 is formed of two foraminous shell portions 102, 103, shown in this example as generally hemispherical. The lower portion 103 in the drawing has an externally threaded rim region 105; the upper portion 102 has an internally threaded rim region 104. The lower shell portion 103 screws into the upper shell portion 102 to form a continuous ball-shaped container shell 106 joined in an equatorial region 108. Because the two shell portions are easily separated and reconnected, a cover as in FIG. 1 is not necessary. Of course, the two shell portions could be fastened together other than by the threaded connection shown. For example, the two halves could be fastened by screws, as in FIG. 1, or could include mating snap connection structure on each shell portion.

Both containers 10, 40 are shown as spheres, but they could have other ball shapes, such as ellipsoidal (like a rugby ball) or polyhedral (like a partially deflated multi-paneled soccer ball). In fact, any convex outer surface of the closed container, whether polyhedral or curved, may work in a given application. The shell and the lid may be made of a plastic material that is rigid, but not brittle. But it may also be made of metal in some applications. Where the container is placed in water, it is preferably neutrally buoyant so that it does not float to the top or sink to the bottom. And the container preferably has properties that make it transparent to the treatment the products are subjected to.

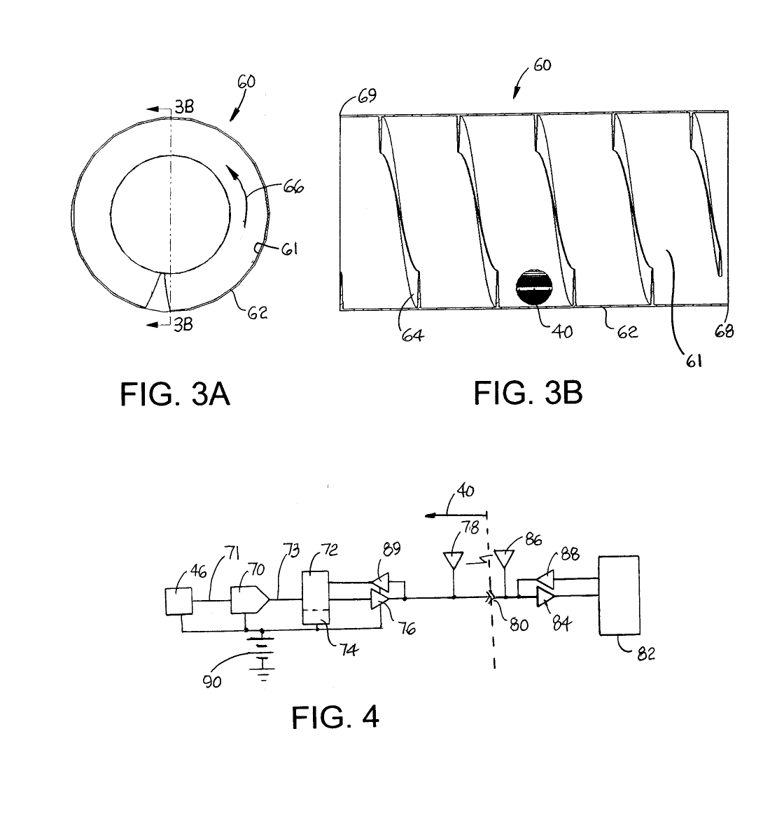

One example of a container as in FIG. 1B or FIG. 2B subjected to an environmental treatment is shown in FIGS. 3A-3B. A rotary blancher 60 comprises a perforate drum 62 mounted in a fluid-filled tank (not shown). A helical flight 64 forms an auger-type screw conveyor. As the drum 62 rotates in the direction indicated by arrow 66, the screw conveyor conveys products inserted at an infeed end 68 to an opposite end 69. The products are subjected to the heated water as they are conveyed along the length of the blancher 60. Generally, the products, which may be vegetables, such as corn or peas, ride up the inside wall 61 of the drum 62 as the screw rotates, but fall back down to the bottom of the drum before they reach the top. This tumbling action continuously mixes the products to make the heat treatment more uniform. The container 40 may be inserted into the rotary blancher 60 along with the mass of products. The container segregates the products it contains from the mass flow so that they may be used as test samples monitored by the sensor during the blanching or checked upon exiting the blancher. The rigid container protects the sensor from damage that can be caused by the tumbling action of the blancher as it conveys products in a continuous process. The convex ball shape allows the container to roll around in the blancher along with the mass flow of products to subject the products it houses to the same treatment.

As shown in FIG. 4, the container with a sensor 46 (as in FIG. 2C) has associated electronic circuitry housed in the lid 42. That circuitry may be realized in many embodiments. One exemplary embodiment includes a signal conditioning circuit 70 including a bridge and an analog-to-digital converter that converts an analog sensor measurement 71 into a digital signal 73, which is applied to a microcomputer 72. The microcomputer includes or is connected to a memory element 74 in which the digitized sensor measurement may be stored for later downloading. A transmitter 76 transmits the digitized sensor measurements in real time wirelessly over an antenna 78 while the container 40 is still in the blancher or other product-tumbling apparatus. The sensor measurement stored in the memory element 74 may also be transmitted wirelessly after the container is retrieved from the blancher. (Alternatively, the stored measurements may be transmitted by wire through a connector 80.) The transmitted measurements are processed by an external processor 82 and the results displayed. A receiver 84 receives the measurements from the transmitter 76 in the container 40 via an antenna 86 or via the connector 80 and inputs them to the external processor 82. The processor 82 can communicate with the microcontroller 72 in the container 40 in one direction over the transmitter 76 and the receiver 84 and in the other direction over a transmitter 88 and a receiver 89 in the container 40. A power supply 90, such as a battery, a rechargeable capacity, or an energy harvesting device, in the container 40 powers the sensor 46 and its associated circuitry.

What is claimed is:

1. A container for housing products undergoing processing in a product-tumbling apparatus, comprising:
a foraminous, ball-shaped shell surrounding an interior chamber and having an outer surface with a multiplicity of small openings extending through the outer surface to the interior chamber and a larger opening extending through the outer surface to the interior chamber;
a removable lid receivable in the larger opening and having an outer surface continuous with the outer surface of the shell when the lid is received in the larger opening;
wherein the small openings are small enough to prevent products from escaping the interior chamber and wherein the larger opening is large enough to allow insertion of the products into and withdrawal of the products from the interior chamber when the lid is removed.

2. A container as in claim 1 wherein the removable lid has a circular threaded region and wherein the shell has threads bounding the larger opening for threadedly engaging the threaded region of the lid.

3. A container as in claim 1 wherein the lid is foraminous.

4. A container as in claim 1 wherein the shell is rigid.

5. A container as in claim 1 wherein the outer surfaces of the shell and the lid are convex.

6. A container as in claim 1 wherein the container is spherical.

7. A container as in claim 1 further comprising a sensor for making measurements of a condition of the products.

8. A container as in claim 7 wherein the sensor has a probe extending into the interior chamber.

9. A container as in claim 8 wherein the sensor probe is insertable into the products in the interior chamber.

10. A container as in claim 7 wherein the sensor is a temperature sensor making temperature measurements.

11. A container as in claim 7 wherein the sensor is mounted in the lid.

12. A container as in claim 7 further comprising a memory element storing the measurements made by the sensor.

13. A container as in claim 7 further containing a wireless transmitter transmitting the measurements made by the sensor.

14. A container as in claim 1 wherein the shell is made of two parts fastened together.

15. A container as in claim 1 wherein the smaller openings provide the outer surface of the shell with an open area of at least 30%.

16. A method for testing a product sample processed in a product-tumbling apparatus, comprising:
inserting a product sample into a foraminous, ball-shaped container having a sensor with a probe penetrating the product sample to make sensor measurements of a condition of the product sample;
admitting the container into a product-tumbling apparatus;
subjecting the product sample in the product-tumbling apparatus to a treatment that affects the condition of the product sample;
downloading the sensor measurements.

17. The method of claim 16 comprising downloading the sensor measurements by transmitting the sensor measurements over a wireless radio link.

18. The method of claim 17 wherein the sensor measurements are downloaded in real time as the product sample is being subjected to the treatment in the product-tumbling apparatus.

19. The method of claim 16 further comprising storing the sensor measurements and downloading the stored sensor measurements when the container is external to the product-tumbling apparatus.

20. The method of claim 16 wherein the product-tumbling apparatus is a rotary blancher and the treatment is blanching in a heated fluid.
